(19) United States
(12) Patent Application Publication
(10) Pub. No.: US 2025/0378484 A1
(43) Pub. Date: Dec. 11, 2025

(54) TAILORING SOFTWARE PRODUCT VERSION UPDATE INFORMATION

(71) Applicant: Dell Products L.P., Round Rock, TX (US)

(72) Inventors: Shelly Goldblit, Haifa (IL); Jehuda Shemer, Kfar Saba (IL); Harel Mazor, Ramot Menashe (IL); Nisreen Awad, Nazareth (IL); Reut Kovetz, Tel Aviv (IL); Ofir Ezrielev, Be'er Sheva (IL)

(21) Appl. No.: 18/736,032

(22) Filed: Jun. 6, 2024

(51) Int. Cl. G06Q 30/0601; G06F 8/61; G06F 8/65; G06F 8/71

(52) U.S. Cl. CPC G06Q 30/0643; G06F 8/63; G06F 8/65; G06F 8/71; G06Q 30/0621; G06Q 30/0631

(57) ABSTRACT

Architectures and techniques are described that can personalize, customize, or otherwise tailor a presentation of product version update information in accordance with certain embodiments of this disclosure. Such can be accomplished by comparing software product version data (e.g., release notes, data from a code repository, data from a documentation repository, . . . ) to customer data (e.g., customer equipment, topology, configuration, settings, . . . ). The tailored output can be tailored to a specific customer, a specific role within the customer organization (e.g., security officer, database administrator, . . . ), or a specific user within the customer organization. The tailored output can be targeted to appeal to a specific audience, increasing the likelihood of prompt acceptance of the new version of the software product.

### BACKGROUND

Providers of a software product frequently roll out new versions of the software product. A new version of the software product can be released for a variety of reasons, including to introduce a new feature or element, to improve performance, to fix bugs, to enhance security, and/or to provide a better user experience. These updates can also help the software product to stay compatible with the latest systems and technologies. Generally, a new version of the software product is provided to the customer for the customer to install. Commonly, the new version is provided with release notes that indicate improvements or other changes over a previous version of the software product.

### BRIEF DESCRIPTION OF THE DRAWINGS

Numerous aspects, embodiments, objects, and advantages of the present embodiments will be apparent upon consideration of the following detailed description, taken in conjunction with the accompanying drawings, in which like reference characters refer to like parts throughout, and in which:

FIG. 1 depicts schematic block diagram illustrating a new version of a software product that is offered to a customer using an older version of the software product in accordance with certain embodiments of this disclosure;

FIG. 2 depicts a schematic block diagram illustrating an example device that can personalize or otherwise tailor a presentation of product version update information in accordance with certain embodiments of this disclosure;

FIG. 3A depicts a schematic block diagram illustrating various examples of the software product data in accordance with certain embodiments of this disclosure;

FIG. 3B depicts a schematic block diagram illustrating various examples of the customer data in accordance with certain embodiments of this disclosure;

FIG. 4A depicts a schematic block diagram illustrating a first example presentation of the tailored software product data in accordance with certain embodiments of this disclosure;

FIG. 4B depicts a schematic block diagram illustrating a second example presentation of the tailored software product data in accordance with certain embodiments of this disclosure;

FIG. 5 depicts a schematic block diagram illustrating an example device that can utilize any combination of derivators to tailor a presentation of product version update information in accordance with certain embodiments of this disclosure;

FIG. 6 depicts a schematic block diagram illustrating additional aspects or elements of the example device that can utilize any combination of derivators to tailor a presentation of product version update information in accordance with certain embodiments of this disclosure;

FIG. 7 illustrates an example method that can customize or otherwise tailor a presentation of product version update information in accordance with certain embodiments of this disclosure;

FIG. 8 illustrates an example method that can provide for additional elements or functionality relating to customizing or otherwise tailoring a presentation of product version update information in accordance with certain embodiments of this disclosure;

FIG. 9 illustrates a block diagram of an example distributed file storage system that employs tiered cloud storage in accordance with certain embodiments of this disclosure; and

FIG. 10 illustrates an example block diagram of a computer operable to execute certain embodiments of this disclosure.

### DETAILED DESCRIPTION

### OVERVIEW

The disclosed subject matter is now described with reference to the drawings, wherein like reference numerals are used to refer to like elements throughout. In the following description, for purposes of explanation, numerous specific details are set forth in order to provide a thorough understanding of the disclosed subject matter. It may be evident, however, that the disclosed subject matter may be practiced without these specific details. In other instances, well-known structures and devices are shown in block diagram form in order to facilitate describing the disclosed subject matter.

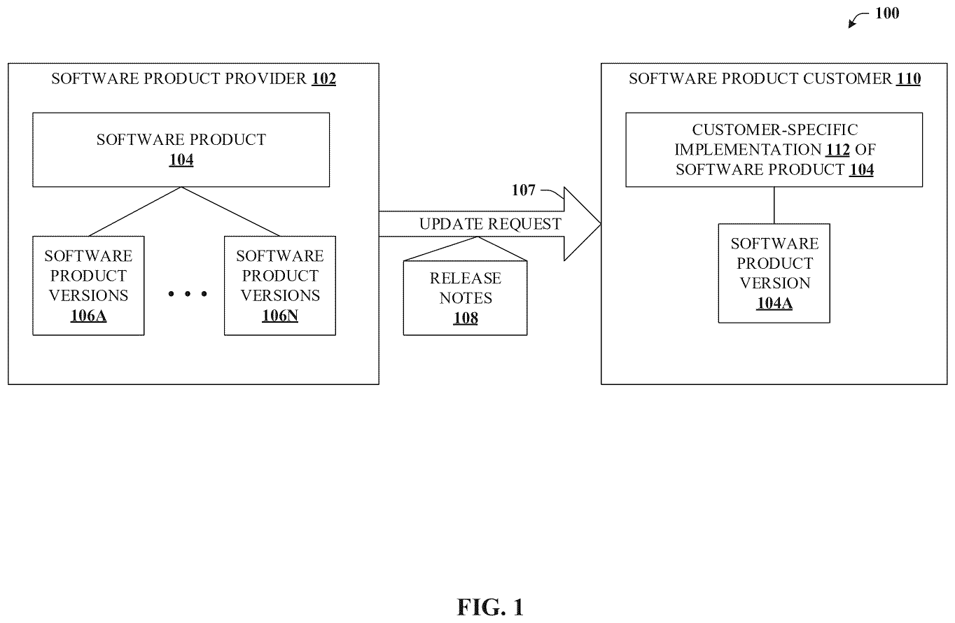

To provide additional context, consider FIG. 1. FIG. 1 shows a schematic block diagram 100 illustrating a new version of a software product that is offered to a customer using an older version of the software product in accordance with certain embodiments of this disclosure.

In that regard, a software product provider 102 can provide software product 104. Over the life cycle of software product 104, many different versions 106 can be developed, shown here as software product versions 106A-106N, where N can be any suitable whole number. The software product can be any suitable software product. However, typically with enterprise software products, software product 104 can be configured differently for one customer 110 than for another customer 110. For example, a first customer 110 may use a first set of features or elements of software product 104, while a second customer 110 may use a second, different, set of features or elements.

Thus, it is a common situation that different customers 110 can have different customer-specific implementations 112 of software product. However, an update to software product generally applies universally to all customer-specific implementations 112. Hence, if customer 110 is using an older version of software product 104, then software product provider 102 can solicit an update request 107 and/or transmit an update notification to customer 110. As noted in the Background section, update notification/request 107 is typically accompanied with general release notes 108.

Generally, software product provider 102 is responsible for maintaining all versions 106 of software product 104 that are in use by customers 110. Therefore, the more and/or older versions that are to be maintained can lead to inefficiencies. For example, having to maintain more versions for a longer time can result in locking developers and supporting staff into non-generative tasks. In addition, maintenance can also be more expensive for older versions. Moreover, having many software product versions 106 operating at the same time relies on extensive backward-compatibility functions, which can limit the development agility for new versions 106.

The inventors have observed that slow product update acceptance can lead to increased risks of system degradation and potential security vulnerabilities. Furthermore, failing to update promptly upon the release of a new version 106 can lead to more complicated and risky updates as the gap between the versions widens, which can cause the update procedure to be more complex with an increased exposure to risks.

Unfortunately, as a group, customers 110 tend to postpone version updates for a variety of reasons. One significant reason version updates are delayed is because customers 110 often fail to understand the benefits of the upgrade, particularly when there exists the potential that the upgrade may cause new issues, whereas the current version (e.g., old version 106) is operating adequately. One reason for this situation is that release notes 108 are comprehensive in nature and can often be dozens of pages or more. Release notes 108 are rarely thoroughly consumed by customers 110, particularly when some portion of the changes may not even be applicable to customer-specific implementation 112. As a result, it is generally difficult for customer 110 to recognize the value of upgrading to a new version.

The disclosed subject matter, in some embodiments, is directed to providing an improved user interface and/or presentation of the potential benefits to upgrading software product 104 from the current/older version 106A implemented by customer 110 to a newer version 106N. To these and other related ends, rather than using general release notes or update notifications, the disclosed techniques can create a tailor-made analysis, identifying the specifics of each customer's environment and deriving the topmost advantages that are specifically relevant for a version update vis-à-vis a customer's unique environment. Such can include factoring in any customizations, settings, policies, and/or any suitable elements of the customer's environment settings that may exist.

For example, certain software product data (e.g., release notes 108, . . . ) can be filtered to remove elements that are not relevant to a particular customer 110 because those elements do not apply for customer implementation 112 or for another reason. The filtered results can be ranked in a customer-specific manner. As another example, if a particular user or other entity of customer 110 has an open service request on a specific defect, then the fix of that defect in the version update can be highlighted for presentation to that particular user, but not necessarily for a different user.

As still another example, performance improvements that are generally discussed in release notes 108 or other documentation can be extrapolated for the customer-specific implementation 112 to arrive at a discrete estimate of the performance improvement for that particular customer-specific implementation 112. As another example, bug fixes or other improvements to features or elements that are frequently used can be weighted more heavily than bug fixes or other improvements to features or elements that are not frequently used. Furthermore, optimizations addressing specific pain points or issues related to resources of that particular customer's environment can be more heavily weighted. Such can include, e.g., storage space, speed, latency, memory, recovery time objective, and so on.

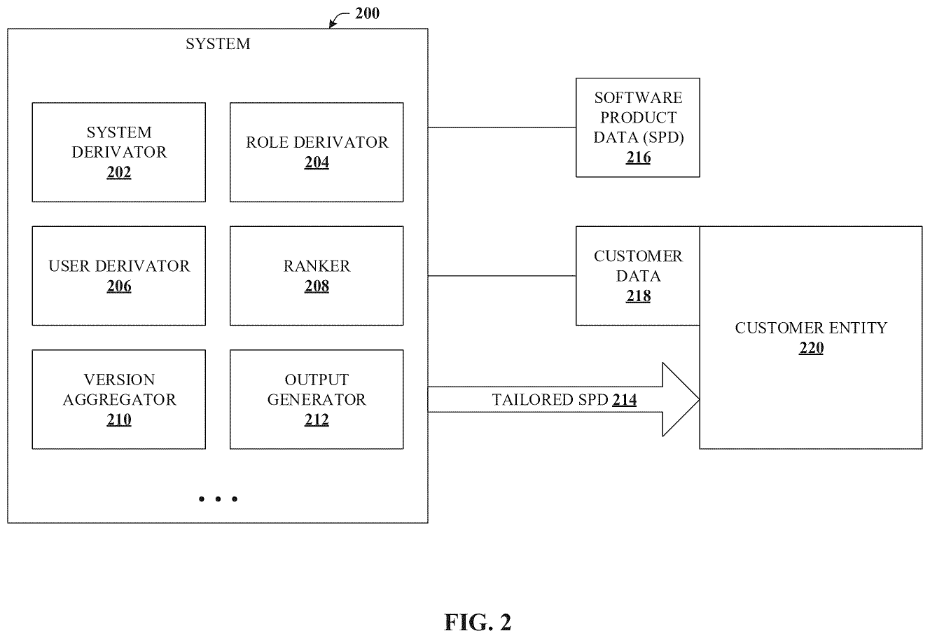

As a potentially advantageous result, customers 110 can better appreciate the advantages of upgrading to a newer version 106 of software product 104 and will therefore be more likely to promptly upgrade to the newer version 106 rather than forestalling the upgrade, the latter of which can lead to greater exposure to risks, reduced efficiency, increased maintenance costs, and other issues. These and other potential advantages provided by the disclosed subject matter can be better understood with reference to FIG. 2 and subsequent FIGS.

### Example Systems

With reference now to FIG. 2, a schematic block diagram is depicted illustrating an example device 200 that can personalize or otherwise tailor a presentation of product version update information in accordance with certain embodiments of this disclosure. In that regard, the presentation of the product version update information can be tailored specifically to a given customer-implementation (e.g., customer-implementation 112) of any suitable software product 104. Additionally or alternatively, system 200 can tailor the presentation to a specific role or user of software product 104, as further detailed below.

System 200 can comprise a system derivator 202, role derivator 204, user derivator 206, ranker 208, version aggregator 210, output generator 212, which are further detailed below, or any other suitable device or element.

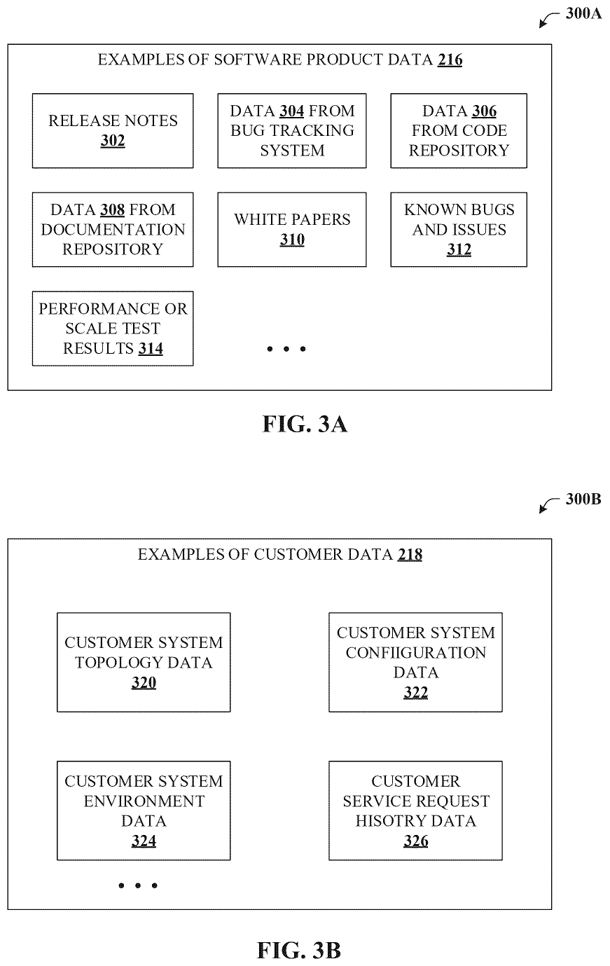

With specific reference to system derivator 202, system derivator 202 can receive software product data 216, which can include any suitable product version-specific change information regarding software product 104. Based on software product data 216 and customer data 218, system derivator 202 can derive output indicative of how the changes in a given software product version 106 will affect the customer-specific implementation 112 of customer entity 220. Examples of software product data 216 and customer data 218 can be found with reference to FIGS. 3A and 3B.

While still referring to FIG. 2, FIGS. 3A and 3B can now be referenced. FIG. 3A depicts a schematic block diagram 300A illustrating various examples of the software product data 216 in accordance with certain embodiments of this disclosure. FIG. 3B depicts a schematic block diagram 300B illustrating various examples of the customer data 218 in accordance with certain embodiments of this disclosure.

With specific reference to FIG. 3A, software product data 216 can comprise release notes 302. Release notes 302 can be similar to release notes 108 detailed in connection with FIG. 1. In more detail, release notes 302 can relate to technical documentation that accompanies the launch of a new software product or a product update such as new version 106. Release notes 302 can provide a brief overview of the changes, enhancements, and bug fixes included in the new version 106.

Software product data 216 can further comprise data 304 that is sourced from a bug tracking system such as, for example, Jira, Bugzilla, or another issue tracking management system or tool. Thus, data 304 can include descriptions relating to bugs, defects, or other issues associated with software product 104. Such can also include feature elements of software product 104, tasks, workflows, user stories, custom fields or other elements relating to software product 104.

Software product data 216 can further comprise data 306 that is sourced from a code change repository system such as, for example, Git. Thus, data 306 can include descriptions relating to code changes, diagnostic reports, repository statistics, commit history, repository information, bug reports, and so forth.

Furthermore, software product data 216 can comprise white papers 310 or other suitable technical documents relating to software product 104, known bugs and issues 312, performance or scale test results 314, or other suitable test results. Generally, software product data 216 can be publicly available or can be maintained by software product provider 102.

With specific reference to FIG. 3B, customer data 218 can comprise customer system topology data 320, customer system configuration data 322, customer system environment data 324, customer service request history data 326, or other suitable data.

Customer system topology data 320 can relate to equipment of customer 110 and how customer equipment is implemented and/or how software product 104 is deployed. Such can include, for instance, a number of nodes, whether the deployment is multi-location, a number of sites, a number of nodes for each site, network topology, and so forth.

Customer system configuration data 322 can relate to how software product 104 is set up or configured. Such can include preferences of customer entity 220, policies of customer entity 220, rules associated with customer entity 220, service level agreements associated with customer entity 220, customizations or settings associated with customer entity 220 and/or customer-specific implementation 112, and so forth.

Customer system environment data 324 can relate to an operating environment of customer entity 220. Such can include what applications are being used in connection with software product 104, a type of orchestration being used (e.g., Kubernetes), whether software product 104 is deployed in a cloud environment, a region associated with customer entity (e.g., geographic region, language, customs, . . . ), and so on.

As another example, customer data 218 can comprise customer service request history data 326, which can relate to service requests that were submitted by a user or other entity of customer entity 220. Generally, customer data 218 can be maintained by software product provider 102 or otherwise obtained from customer entity 220. Much of customer data 218 can be obtained via telemetry, logs, system configuration, and so forth.

Still referring to FIG. 2 and the discussion of system derivator 202, it is to be understood that software product data 216 (e.g., release notes 302, and other data) is readily available with every release of a new version 106 of software product 104 and customer have access to all or most of release notes 302. However, it has been observed that customers seldom read through the release notes 302 (e.g., 10-20 pages or more), and even more rarely the full documentation or other material. A potential reason is that it is too much data with too little relevance is commonly provided by release notes 302. To narrow down the amount of data and improve relevance, system derivator 202 can identify the parts pertaining to the specific system of customer entity 220 (e.g., customer-specific implementation 112).

Most systems of customer entity 220 are usually set up to send telemetry information including topology, configuration, security settings, environment, and other suitable customer data 218. Alternatively, system 200 can connect to the system customer entity 220 to discover such information. From the customer data 218, determinations regarding what features and components the system of customer entity 220 actually uses. By intersecting the product version information (e.g., software product data 216) and the customer system information (e.g., customer data 218), system derivator 202 can derive a subset of version information that is relevant to the specific system, and even the level of impact of a specific change. Moreover, customer support history, both open tickets and past issues (e.g., customer service request history data 326) may be leveraged to pinpoint the relevance of changes within a new version 106 software product 104.

As one example, system derivator 202 can determine changes between two different versions 106 of software product 104 by observing data 306 sourced from a code repository and/or data 308 sourced from a documentation repository. A released version is commonly tagged in the source code as well as documentation repositories. Major version differences can be precalculated. Differences can likewise be calculated for compensation of hot-fixes or the like.

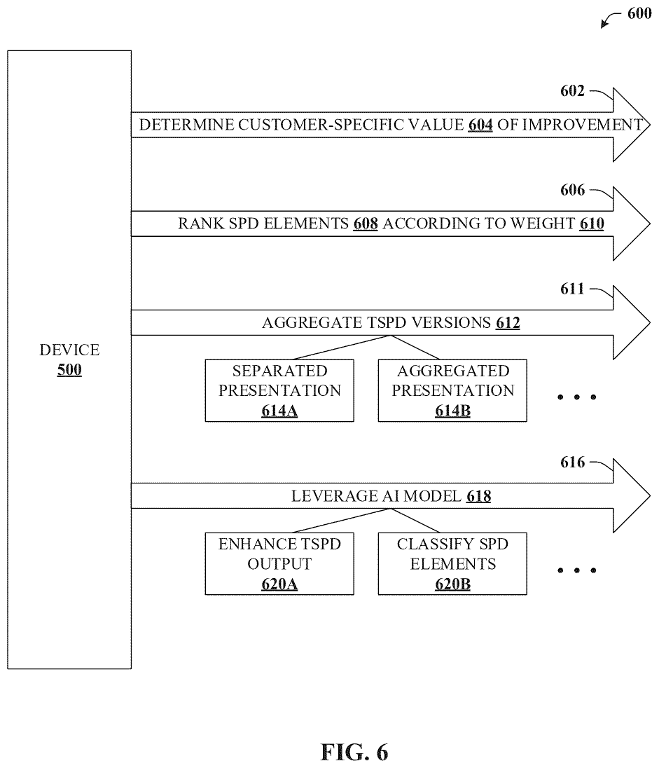

Changes in the repositories are usually marked with Jira items or the like (or such can be derived). Moreover, the flows and settings used in a customer-specific implementation 112 can be matched to the code areas where changes have been made. In some embodiments, such can be done according to an artificial intelligence (AI) classification model, which is further detailed in connection with FIG. 6.

Certain flows and settings used in a given customer-specific implementation 112 can be matched to the code areas where changes have been made for a new version 106. As a result, system derivator 202 can determine areas and associated flows relevant to customer-specific implementation 112 that is specific to and/or tailored for customer entity 220, which is referred to here as tailored software product data 214. More specifically, system derivator 202 can filter software product data 216 to be system-specific to customer entity 220

In contrast, role derivator 204 can filter the output of system derivator which is already system-specific (or even unfiltered software product data 216), according to a role specified by software product 104. For example, a given set of login credentials used to login to software product 104 can be tied to specific role-based permissions and so forth. Examples can include a service reliability engineer role that is typically interested in scalability or available, a database administration role that is typically interested in improvements in performance relating to databases or storages, an information security officer role that is typically interested in security-related improvements, a infrastructure administrator role that is typically interested in infrastructure elements of customer-specific implementation 112, a data protection administrator that is typically interested in backup operations, or any other suitable role.

User derivator 206 can function similar to role derivator 204, but instead of specifically focusing on the role of a given individual from company entity 220, actions or behavior of the specific user can be leveraged. For example, user derivator 206 can identify positive effects of new version 106 that are applicable to flows or workloads that particular user is responsible for. As another example, user derivator 206 can identify whether a particular user submitted a service request that is directed to an issue associated with the current/older version 106 that can be completely or partially solved by the newer version 106. As with role derivator 204, user derivator 206 can accept as input the output of system derivator 202, so that the input is already filtered for customer-specific implementation 112, or accept as input software product data 216 in its entirety. In some embodiments, user derivator 206 can receive as input the output of role derivator 204.

Ranker 208 can rank the output (e.g., software product data 216 that has been filtered in some manner) of any of system derivator 202, role derivator 204, or user derivator 206, thereby selecting or ordering items that are most particularly relevant to a given member of customer entity 220.

In some embodiments, ranker 208 can identify the most significant and/or most relevant changes of the newer version 106 based on the significance of the change, the importance of the flow where the change applies, which can be determined from the system, role, or user perspective, the potential or actual change in a value (e.g., performance, limit, scale, . . . ), or based on other information.

Various weights determined for a given item that has changed can be combined in any suitable way. One example can be according to the following:
For each item:
   Calculate the weights wᵢ

$${V}_{item} = \sum {w}_{i}$$

Sort items on Vᵢₜₑₘ in decreasing order

Version Aggregator 210 can receive as input all or a portion (e.g., the top three or four highest ranked items) of the output of ranker 208, which can be indicative of a ranked, sorted list of the items that changed from the older version to the newer version of software produce 104. In terms of presenting the most relevant (e.g., highest ranked) items from among software product data 216, such can account for the possibility that the upgrade can encompass multiple newer versions than the older version customer entity 220 is currently using.

In that regard, two different approaches can be used, namely a separate approach in which the benefits of each version are presented separately, or an aggregated approach in which the benefits of the newest version and all intermediate versions are presented together.

In the aggregated approach, issues and bug fixes can be simply combined. Limits and performance values may be adjusted using, e.g., a max/min function or multiplication in the case of percentage increases or relative index measure. After the aggregation and adjustments, the same ranking process described herein can be utilized.

As stated, the differences between major version updates can be precalculated, so the combination can be done in a rather straightforward manner. There should also be a compensation for hotfixes. For instance, any fixes or functionality applied by specific hotfixes on the specific system, can be added/removed from the aggregated result.

Output generator 212 can be configured to derive the text items for the system using all or a portion of the above-noted outputs and/or devices. Such can take into consideration customer data 218, which can comprise system data and user/role data and associated rankings. Such can be accomplished in multiple ways, as indicated below.

For example, software product data 216 (e.g., release notes 302) can be filtered or identified relevant excerpts can be extracted from the text. From this filtered subset, certain portions can be tagged or highlighted as significant or especially relevant. Thereafter, an AI model such as a retrieval augmented generation (RAG) model or a large language model (LLM) can be leveraged. For instance, the AI model can build a vector base from software product data 216 and select vectors according to the subsequent analysis in order to generate the text that is to appear in tailored SPD 214.

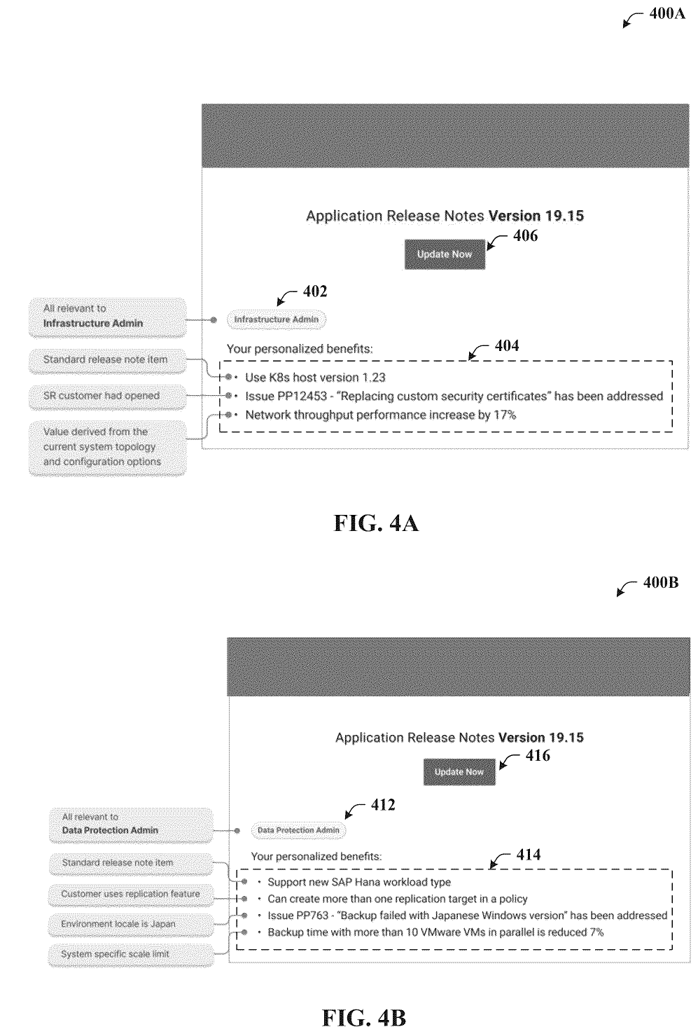

These different techniques can differ in the accuracy of the results, and the ability to add system specific information, or target communication style and language. It is noted that an LLM can also target different languages, nomenclature, or organization specific jargon. FIGS. 4A and FB are representative examples of the tailored SPD 214 that can be compared to, or contrasted with, typical release notes that can be dozens of pages in length and typically yield exceedingly low thorough consumption rates.

With reference now to FIGS. 4A and 4B, FIG. 4A depicts a schematic block diagram 400A illustrating a first example presentation of the tailored software product data 214 in accordance with certain embodiments of this disclosure. FIG. 4B depicts a schematic block diagram 400B illustrating a second example presentation of the tailored software product data 214 in accordance with certain embodiments of this disclosure. As shown, the tailored SPD 214 can be presented in response to a user logging into the software product 104. In that case, the identities of customer entity 220 and the particular user and associated role can be known and utilized in the manner detailed herein to direct the personalization of tailored SPD 214. As illustrated, upon login, a popup message can be generated or another suitable vehicle can be utilized to present tailored SPD 214.

As indicated at reference numeral 402, the presentation is specifically directed to the role of infrastructure administrator. Hence, the ranked items, three in this example, are those that are specifically relevant to an infrastructure administrator (e.g., role-based), as illustrated at reference numeral 404. In this example, the first item indicates that Kubernetes host 1.23 is used, which can be particularly relevant. Such can be derived or extracted from release notes 302.

The next item relates to a service request this particular user submitted. Such can represent a user-based ranking, as such is likely to be extremely interesting to this particular user. The third item relates to an improvement to the throughput performance of software product 104. The value indicated here (e.g., increase by 17%) can be derived from the customer-specific implementation 112 topology and configurations options. It is noted that this value can differ for different customer entities 220 having different customer-specific implementations 112. It is further noted that if the value is significantly less for a different topology or configuration, this particular item may not be ranked as highly. The presentation can comprise a link or prompt to update now, as indicated at reference numeral 406.

With specific reference to FIG. 4B, as indicated at reference numeral 412, the presentation is specifically directed to the role of data protection administrator. Hence, the ranked items, four in this example, are those that are specifically relevant to a data protection administrator (e.g., role-based), as illustrated at reference numeral 414. In this example, the first item indicates that a new feature has been added, namely, support for SAP Hana workload types have been added to the new version. Such can be derived or extracted from release notes 302.

The next item relates to another improvement, in this case the ability to create more than one replication target in a policy. Such can be relevant and highly ranked, e.g., because this particular customer frequently uses the replication feature, or potentially because this particular user previously requested a similar feature. The next item indicates that a known issue with Japanese Windows version has been fixed. Such can be relevant and highly ranked because, for example, this particular customer entity resides in Japan, which can be determined from customer data 218. The last item relates to a performance improvement for backup procedures. In this example, the 7% reduction can be calculated specifically for the deployment associated with the particular customer entity. The presentation can comprise a link or prompt to update now, as indicated at reference numeral 416.

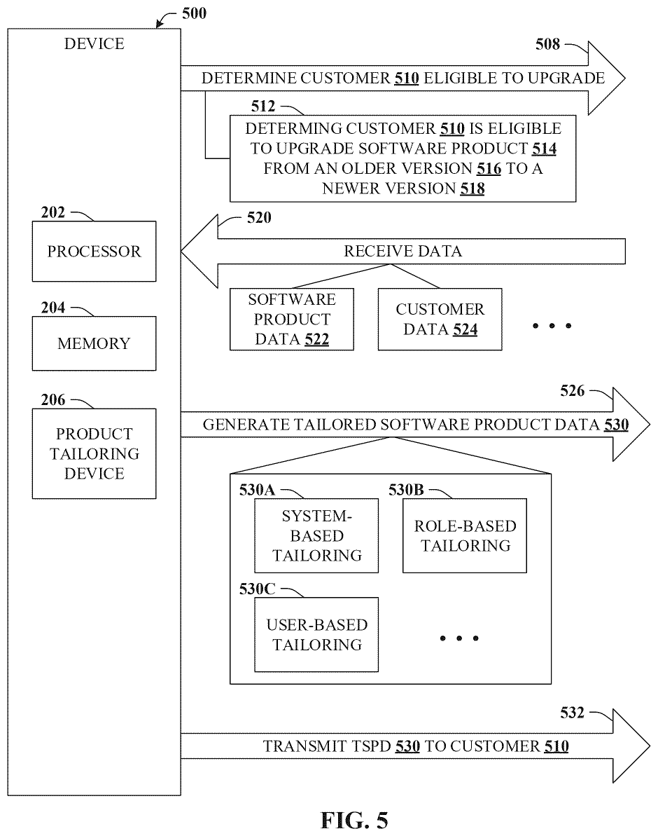

With reference now to FIG. 5, a schematic block diagram is depicted illustrating an example device 500 that can utilize any combination of derivators to tailor a presentation of product version update information in accordance with certain embodiments of this disclosure. In that regard, the presentation of the product version update information can be tailored specifically to a given customer-implementation (e.g., customer-implementation 112) of any suitable software product 104. Additionally or alternatively, system 200 can tailor the presentation to a specific role or user of software product 104, as further detailed below.

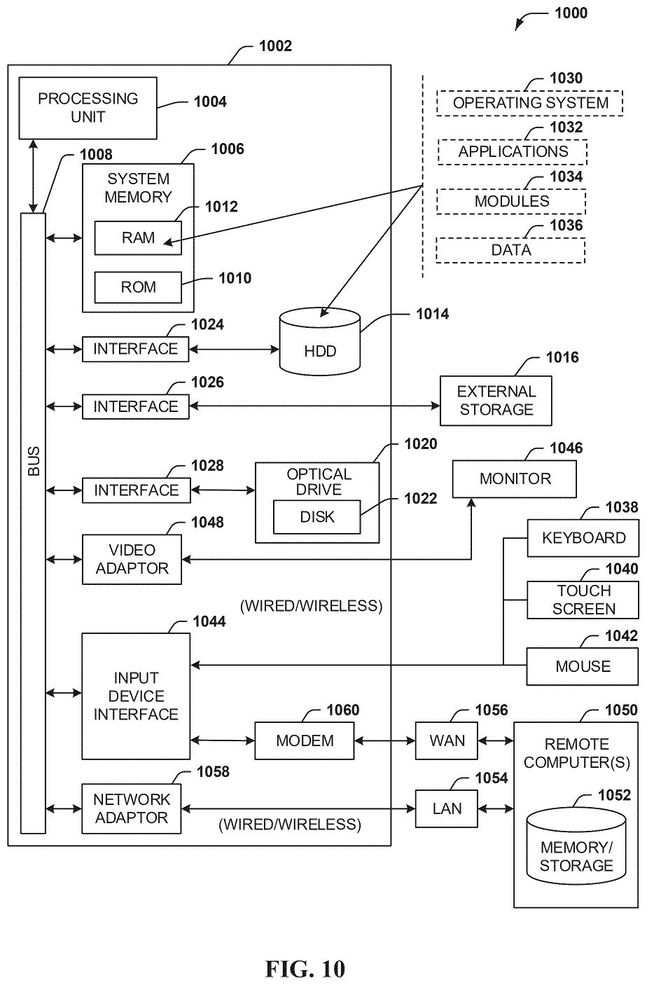

Device 500 can comprise at least one processor 502 that, potentially along with product tailoring device 506, can be specifically configured to perform functions associated with customizing and/or tailoring software product data to a specific audience rather than comprehensive and general release notes that are not frequently examined in detail. Device 500 can also comprise at least one memory 504 that stores executable instructions that, when executed by the at least one processor 502, can facilitate performance of operations. Processor(s) 502 can be a hardware processor having structural elements known to exist in connection with processing units or circuits, with various operations of processor 502 being represented by functional elements shown in the drawings herein that can require special-purpose instructions, for example, stored in memory 504 and/or product tailoring device 506. Along with these special-purpose instructions, processor 502 and/or product tailoring device 506 can be a special-purpose device. Further examples of the memory 504 and processor 502 can be found with reference to FIG. 10. It is to be appreciated that device 500 or computer 1002 can represent a server device or a client device of a network or data services platform and computer 1002 can be used in connection with implementing one or more of the systems, devices, or components shown and described in connection with FIG. 5 and other figures disclosed herein.

As illustrated at reference numeral 508, device 500 can determine whether customer 510 (e.g., customer entity 220) is eligible to upgrade. In more detail, as indicated at reference numeral 512, device 500 can determine that customer 510 is eligible to upgrade software product 514 (e.g., software product 104) from an older version 516 (e.g., version 106A) to a newer version 518 (e.g., version 106N). In some embodiments, eligibility can be determined by identifying that customer 510 has not upgraded to newer version 518 but rather is still implementing older version 516. In some embodiments, eligibility can be further qualified such that one or more conditions or criteria is to be satisfied before confirming eligibility.

In response to customer 510 being determined to be eligible for the upgrade, at reference numeral 520, device 500 can receive various data that can be used for tailoring. For example, the received data can comprise software product data 522 (e.g., SPD 216), customer data 524 (e.g., customer data 218), or other suitable data. Software product data 522 can comprise change data that describes at least one change made to newer version 514 with respect to older version 516. By way of example, software product data can include, e.g., release notes 302 associated with newer version 518 as well as other suitable data such as that described in connection with elements 302-314 of FIG. 3A, including data 306 from a code repository, data 308 from a documentation repository, data 304 from a bug tracking system, white papers 310, known bugs and issues 312, performance or scale test results 314, or other suitable data.

Customer data 524 can be indicative of a particular implementation of software product 514 that is deployed by a given customer 510. Examples can include customer system topology data 320, customer system configuration data 322, customer system environment data 324, customer service request history data 326, as detailed in connection with FIG. 3B, or other suitable data.

Based on customer data 524 (e.g., that intersects with software product data 522), device 500 can generate tailored SPD 530. Tailored SPD 530 can be generated by filtering the SPD 216 by appropriate customer data 524 in order to exclude elements of SPD 216 that are determined not to be relevant. Such filtering can be in accordance with system-based tailoring 530A, role-based tailoring 530B, user-based tailoring 530C, or another suitable type.

System-based tailoring 530A can exclude elements that are determined not to be relevant to the customer-specific implementation 112 of software product 514. Role-based tailoring 530B can exclude elements that are determined not to be relevant to defined role associated with software product 514 (e.g., security officer role, database administrator role, . . . ). User-based tailoring 530C can exclude elements that are determined not to be relevant to a defined user associated with software product 514 and/or customer 510. It is understood that any of the various types of filtering 530A-530C or others can be applied individually or in combination with one another. It is further understood that when applying multiple types of filtering 530A-530C, either the SPD 216 can be filtered or the (previously filtered) output from one type can be input to another type.

At reference numeral 532, device 500 can transmit tailored SPD 530 to customer 510. In some embodiments, device 500 can cause or facilitate a presentation of tailored SPD 530 on a device associated with customer 510. This presentation can take the form of a popup in response to a login, as illustrated in connection with FIGS. 4A and 4B, or another suitable form, such as an email, a text message, or the like.

With reference now to FIG. 6, a schematic block diagram 600 is depicted illustrating additional aspects or elements of the example device 500 that can utilize any combination of derivators to tailor a presentation of product version update information in accordance with certain embodiments of this disclosure.

For example, at reference numeral 602, device 500 can determine a customer-specific value 604 for an improvement indicated by SPD 216. In that regard, device 500 can determine that a portion of the SPD 216 or tailored SPD 530 relates to an improvement having a variable value that is a function of a deployment implementation of software product 514. This variable value can be calculated or estimated based on the customer-specific implementation 112 in order to arrive at customer-specific value 604. In some embodiments, customer-specific value 604 can be included in tailored SPD 530 and/or a presentation of tailored SPD 530.

At reference numeral 606, device 500 can rank items or elements 608 of SPD 216 and/or tailored SPD 530 according to weight 610. These items or elements 608 can relate to features or the like associated SPD 216 and/or tailored SPD 530. Weights 620 can be assigned as was detailed in connection with ranker 208 of FIG. 2.

At reference numeral 611, device 500 can aggregate various versions 612 of tailored SPD 530. For example, in situations in which at least one intermediate version exists between older version 516 and newer version 518, the tailored information that is presented can be according to a separated presentation 614A in which the output generated for each version after older version 516 is presented separately, or according to an aggregated presentation 614B in which the combined output generated for each version after older version 516 is presented.

At reference numeral 616, device 500 can leverage an AI model 618. As detailed previously, AI model 618 can be a RAG, an LLM, or another suitable model. In some embodiments, AI model 618 can be leveraged to enhance output 620A of tailored SPD 530. For example, the language and/or text associated tailored SPD 530 can be generated to be more readable or personable as opposed to verbatim excerpts from technical documents. In some embodiments, AI model 618 can be leveraged to classify the features or items (e.g., elements 608) associated with a version update.

### Example Methods

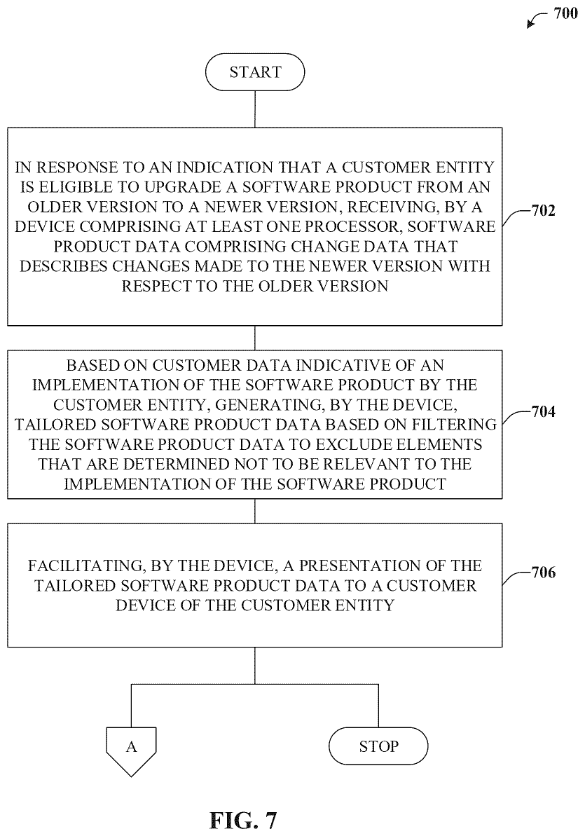

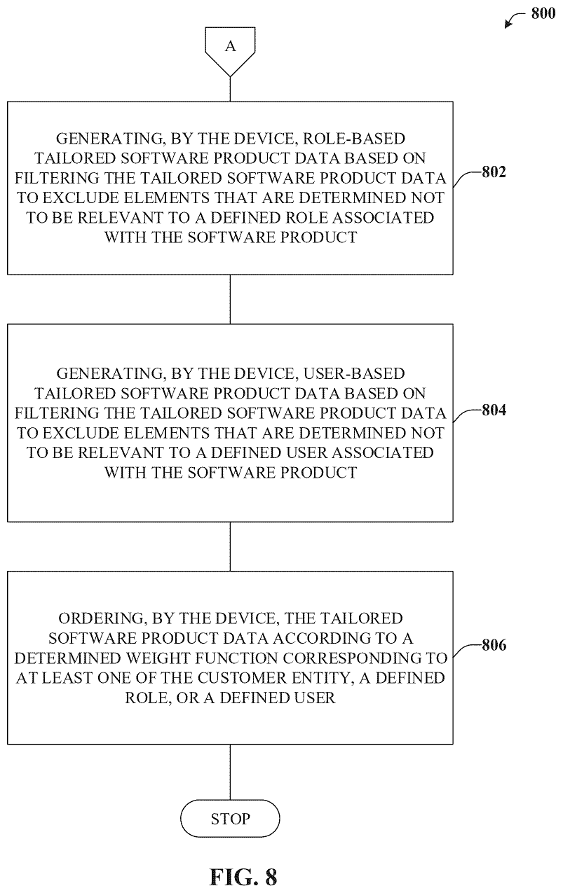

FIGS. 7 and 8 illustrate various methods in accordance with the disclosed subject matter. While, for purposes of simplicity of explanation, the methods are shown and described as a series of acts, it is to be understood and appreciated that the disclosed subject matter is not limited by the order of acts, as some acts may occur in different orders and/or concurrently with other acts from that shown and described herein. For example, those skilled in the art will understand and appreciate that a method could alternatively be represented as a series of interrelated states or events, such as in a state diagram. Moreover, not all illustrated acts may be required to implement a method in accordance with the disclosed subject matter. Additionally, it should be further appreciated that the methods disclosed hereinafter and throughout this specification are capable of being stored on an article of manufacture to facilitate transporting and transferring such methods to computers.

Turning now to FIG. 7, exemplary method 700 is depicted. Method 700 can customize or otherwise tailor a presentation of product version update information in accordance with certain embodiments of this disclosure. While method 700 describes a complete method, in some embodiments, method 700 can include one or more elements of method 800, reached via insert A, as discussed at FIG. 8.

At reference numeral 702, in response to an indication that a customer entity is eligible to upgrade a software product from an older version to a newer version, a device comprising at least one processor can receive software product data comprising change data that describes changes made to the newer version with respect to the older version. The device can further receive customer data that is indicative of an implementation of the software product by the customer entity.

At reference numeral 704, based on the customer data, the device can generate tailored software product data based on filtering the software product data to exclude elements that are determined not to be relevant to the implementation of the software product. Such a determination can be made in part upon determining that a particular element of the software product data does not intersect or match associated customer data. Relevance can further be established by ranking or weighting procedures via comparing the software product data to the customer data.

At reference numeral 706, the device can transmit the tailored software product data and/or cause or facilitate a presentation of the tailored software product data on a customer device of the customer entity. As noted, such can be in the form of a popup or dialog box that is presented in response to a system login to the software product. Method 700 can terminate in some embodiments, or proceed to insert A in other embodiments, which is further detailed in connection with FIG. 8.

Turning now to FIG. 8, exemplary method 800 is depicted. Method 800 can provide for additional elements or functionality relating to customizing or otherwise tailoring a presentation of product version update information in accordance with certain embodiments of this disclosure.

For example, at reference numeral 802, the device introduced in connection with FIG. 7 can generate role-based tailored software product data based on filtering the tailored software product data to exclude elements that are determined not to be relevant to a defined role associated with the software product. In some embodiments, the role-based tailored software product data can be generated from the software product data instead of the tailored software product data.

A reference numeral 804, the device can generate user-based tailored software product data based on filtering the tailored software product data to exclude elements that are determined not to be relevant a defined user associated with the software product t. In some embodiments, the user-based tailored software product data can be generated from the software product data instead of the tailored software product data.

A reference numeral 806, the device can order the tailored software product data according to a determined weight function. In some embodiments, the device can similarly order the role-based tailored software product data or the user-based tailored software product data according to the determined weight function. The determined weight function can correspond to at least one of a customer-specific implementation of the software product by the customer entity, a defined role, or a defined user.

### Example Operating Environments

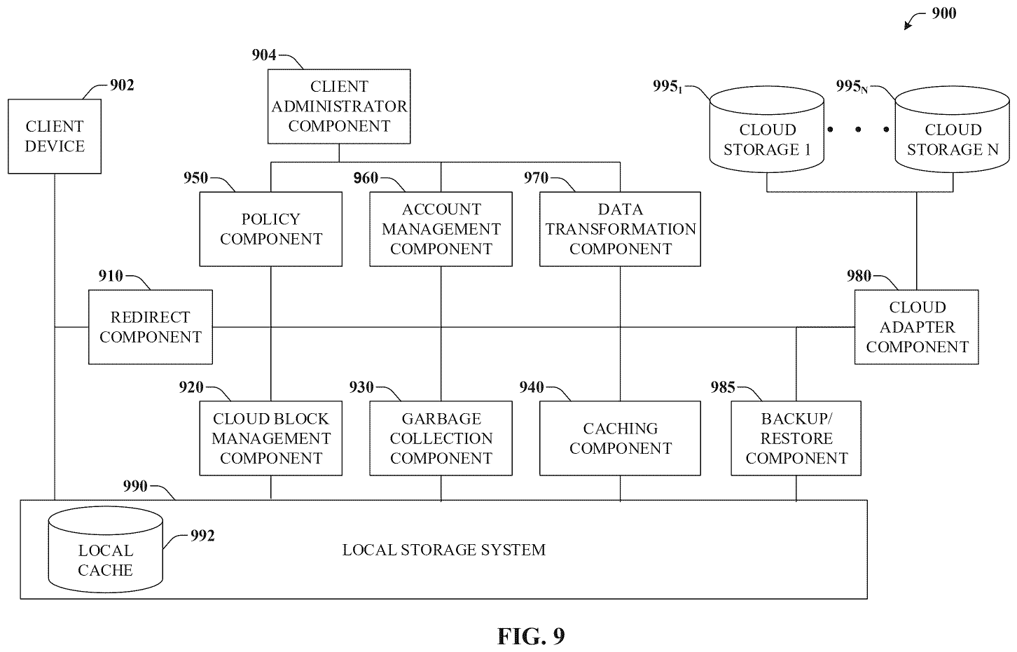

To provide further context for various example embodiments of the subject specification, FIGS. 9 and 10 illustrate, respectively, a block diagram of an example distributed file storage system 900 that employs tiered cloud storage and block diagram of a computer 1002 operable to execute the disclosed storage architecture in accordance with example embodiments described herein.

Referring now to FIG. 9, there is illustrated an example local storage system including cloud tiering components and a cloud storage location in accordance with implementations of this disclosure. Client device 902 can access local storage system 990. Local storage system 990 can be a node and cluster storage system such as an EMC Isilon Cluster that operates under OneFS operating system. Local storage system 990 can also store the local cache 992 for access by other components. It can be appreciated that the systems and methods described herein can run in tandem with other local storage systems as well.

As more fully described below with respect to redirect component 910, redirect component 910 can intercept operations directed to stub files. Cloud block management component 920, garbage collection component 930, and caching component 940 may also be in communication with local storage system 990 directly as depicted in FIG. 9 or through redirect component 910. A client administrator component 904 may use an interface to access the policy component 950 and the account management component 960 for operations as more fully described below with respect to these components. Data transformation component 970 can operate to provide encryption and compression to files tiered to cloud storage. Cloud adapter component 980 can be in communication with cloud storage 1 995₁ and cloud storage N 995_{N}, where N is a positive integer. It can be appreciated that multiple cloud storage locations can be used for storage including multiple accounts within a single cloud storage location as more fully described in implementations of this disclosure. Further, a backup/restore component 985 can be utilized to back up the files stored within the local storage system 990.

Cloud block management component 920 manages the mapping between stub files and cloud objects, the allocation of cloud objects for stubbing, and locating cloud objects for recall and/or reads and writes. It can be appreciated that as file content data is moved to cloud storage, metadata relating to the file, for example, the complete inode and extended attributes of the file, still are stored locally, as a stub. In one implementation, metadata relating to the file can also be stored in cloud storage for use, for example, in a disaster recovery scenario.

Mapping between a stub file and a set of cloud objects models the link between a local file (e.g., a file location, offset, range, etc.) and a set of cloud objects where individual cloud objects can be defined by at least an account, a container, and an object identifier. The mapping information (e.g., mapinfo) can be stored as an extended attribute directly in the file. It can be appreciated that in some operating system environments, the extended attribute field can have size limitations. For example, in one implementation, the extended attribute for a file is 8 kilobytes. In one implementation, when the mapping information grows larger than the extended attribute field provides, overflow mapping information can be stored in a separate system b-tree. For example, when a stub file is modified in different parts of the file, and the changes are written back in different times, the mapping associated with the file may grow. It can be appreciated that having to reference a set of non-sequential cloud objects that have individual mapping information rather than referencing a set of sequential cloud objects, can increase the size of the mapping information stored. In one implementation, the use of the overflow system b-tree can limit the use of the overflow to large stub files that are modified in different regions of the file.

File content can be mapped by the cloud block management component 920 in chunks of data. A uniform chunk size can be selected where all files that are tiered to cloud storage can be broken down into chunks and stored as individual cloud objects per chunk. It can be appreciated that a large chunk size can reduce the number of objects used to represent a file in cloud storage; however, a large chunk size can decrease the performance of random writes.

The account management component 960 manages the information for cloud storage accounts. Account information can be populated manually via a user interface provided to a user or administrator of the system. Each account can be associated with account details such as an account name, a cloud storage provider, a uniform resource locator (“URL”), an access key, a creation date, statistics associated with usage of the account, an account capacity, and an amount of available capacity. Statistics associated with usage of the account can be updated by the cloud block management component 920 based on a list of mappings that the cloud block management component 920 manages. For example, each stub can be associated with an account, and the cloud block management component 920 can aggregate information from a set of stubs associated with the same account. Other example statistics that can be maintained include the number of recalls, the number of writes, the number of modifications, and the largest recall by read and write operations, etc. In one implementation, multiple accounts can exist for a single cloud service provider, each with unique account names and access codes.

The cloud adapter component 980 manages the sending and receiving of data to and from the cloud service providers. The cloud adapter component 980 can utilize a set of APIs. For example, each cloud service provider may have provider specific API to interact with the provider.

A policy component 950 enables a set of policies that aid a user of the system to identify files eligible for being tiered to cloud storage. A policy can use criteria such as file name, file path, file size, file attributes including user generated file attributes, last modified time, last access time, last status change, and file ownership. It can be appreciated that other file attributes not given as examples can be used to establish tiering policies, including custom attributes specifically designed for such purpose. In one implementation, a policy can be established based on a file being greater than a file size threshold and the last access time being greater than a time threshold.

In one implementation, a policy can specify the following criteria: stubbing criteria, cloud account priorities, encryption options, compression options, caching and IO access pattern recognition, and retention settings. For example, user selected retention policies can be honored by garbage collection component 930. In another example, caching policies such as those that direct the amount of data cached for a stub (e.g., full vs. partial cache), a cache expiration period (e.g., a time period where after expiration, data in the cache is no longer valid), a write back settle time (e.g., a time period of delay for further operations on a cache region to guarantee any previous writebacks to cloud storage have settled prior to modifying data in the local cache), a delayed invalidation period (e.g., a time period specifying a delay until a cached region is invalidated thus retaining data for backup or emergency retention), a garbage collection retention period, backup retention periods including short term and long term retention periods, etc.

A garbage collection component 930 can be used to determine which files/objects/data constructs remaining in both local storage and cloud storage can be deleted. In one implementation, the resources to be managed for garbage collection include CMOs, cloud data objects (CDOs) (e.g., a cloud object containing the actual tiered content data), local cache data, and cache state information.

A caching component 940 can be used to facilitate efficient caching of data to help reduce the bandwidth cost of repeated reads and writes to the same portion (e.g., chunk or sub-chunk) of a stubbed file, can increase the performance of the write operation, and can increase performance of read operations to portion of a stubbed file accessed repeatedly. As stated above with regards to the cloud block management component 920, files that are tiered are split into chunks and in some implementations, sub chunks. Thus, a stub file or a secondary data structure can be maintained to store states of each chunk or sub-chunk of a stubbed file. States (e.g., stored in the stub as cacheinfo) can include a cached data state meaning that an exact copy of the data in cloud storage is stored in local cache storage, a non-cached state meaning that the data for a chunk or over a range of chunks and/or sub chunks is not cached and therefore the data has to be obtained from the cloud storage provider, a modified state or dirty state meaning that the data in the range has been modified, but the modified data has not yet been synched to cloud storage, a sync-in-progress state that indicates that the dirty data within the cache is in the process of being synced back to the cloud and a truncated state meaning that the data in the range has been explicitly truncated by a user. In one implementation, a fully cached state can be flagged in the stub associated with the file signifying that all data associated with the stub is present in local storage. This flag can occur outside the cache tracking tree in the stub file (e.g., stored in the stub file as cacheinfo), and can allow, in one example, reads to be directly served locally without looking to the cache tracking tree.

The caching component 940 can be used to perform at least the following seven operations: cache initialization, cache destruction, removing cached data, adding existing file information to the cache, adding new file information to the cache, reading information from the cache, updating existing file information to the cache, and truncating the cache due to a file operation. It can be appreciated that besides the initialization and destruction of the cache, the remaining five operations can be represented by four basic file system operations: Fill, Write, Clear and Sync. For example, removing cached data is represented by clear, adding existing file information to the cache by fill, adding new information to the cache by write, reading information from the cache by read following a fill, updating existing file information to the cache by fill followed by a write, and truncating cache due to file operation by sync and then a partial clear.

In one implementation, the caching component 940 can track any operations performed on the cache. For example, any operation touching the cache can be added to a queue prior to the corresponding operation being performed on the cache. For example, before a fill operation, an entry is placed on an invalidate queue as the file and/or regions of the file will be transitioning from an uncached state to cached state. In another example, before a write operation, an entry is placed on a synchronization list as the file and/or regions of the file will be transitioning from cached to cached-dirty. A flag can be associated with the file and/or regions of the file to show that the file has been placed in a queue and the flag can be cleared upon successfully completing the queue process.

In one implementation, a time stamp can be utilized for an operation along with a custom settle time depending on the operations. The settle time can instruct the system how long to wait before allowing a second operation on a file and/or file region. For example, if the file is written to cache and a write back entry is also received, by using settle times, the write back can be re-queued rather than processed if the operation is attempted to be performed prior to the expiration of the settle time.

In one implementation, a cache tracking file can be generated and associated with a stub file at the time the stub file is tiered to the cloud. The cache tracking file can track locks on the entire file and/or regions of the file and the cache state of regions of the file. In one implementation, the cache tracking file is stored in an Alternate Data Stream (“ADS”). It can be appreciated that ADS are based on the New Technology File System (“NTFS”) ADS. In one implementation, the cache tracking tree tracks file regions of the stub file, cached states associated with regions of the stub file, a set of cache flags, a version, a file size, a region size, a data offset, a last region, and a range map.

In one implementation, a cache fill operation can be processed by the following steps: (1) an exclusive lock on can be activated on the cache tracking tree; (2) it can be verified whether the regions to be filled are dirty; (3) the exclusive lock on the cache tracking tree can be downgraded to a shared lock; (4) a shared lock can be activated for the cache region; (5) data can be read from the cloud into the cache region; (6) update the cache state for the cache region to cached; and (7) locks can be released.

In one implementation, a cache read operation can be processed by the following steps: (1) a shared lock on the cache tracking tree can be activated; (2) a shared lock on the cache region for the read can be activated; (3) the cache tracking tree can be used to verify that the cache state for the cache region is not “not cached;” (4) data can be read from the cache region; (5) the shared lock on the cache region can be deactivated; (6) the shared lock on the cache tracking tree can be deactivated.

In one implementation, a cache write operation can be processed by the following steps: (1) an exclusive lock on can be activated on the cache tracking tree; (2) the file can be added to the synch queue; (3) if the file size of the write is greater than the current file size, the cache range for the file can be extended; (4) the exclusive lock on the cache tracking tree can be downgraded to a shared lock; (5) an exclusive lock can be activated on the cache region; (6) if the cache tracking tree marks the cache region as “not cached” the region can be filled; (7) the cache tracking tree can updated to mark the cache region as dirty; (8) the data can be written to the cache region; (9) the lock can be deactivated.

In one implementation, data can be cached at the time of a first read. For example, if the state associated with the data range called for in a read operation is non-cached, then this would be deemed a first read, and the data can be retrieved from the cloud storage provider and stored into local cache. In one implementation, a policy can be established for populating the cache with range of data based on how frequently the data range is read; thus, increasing the likelihood that a read request will be associated with a data range in a cached data state. It can be appreciated that limits on the size of the cache, and the amount of data in the cache can be limiting factors in the amount of data populated in the cache via policy.

A data transformation component 970 can encrypt and/or compress data that is tiered to cloud storage. In relation to encryption, it can be appreciated that when data is stored in off-premises cloud storage and/or public cloud storage, users can request or require data encryption to ensure data is not disclosed to an illegitimate third party. In one implementation, data can be encrypted locally before storing/writing the data to cloud storage.

In one implementation, the backup/restore component 985 can transfer a copy of the files within the local storage system 990 to another cluster (e.g., target cluster). Further, the backup/restore component 985 can manage synchronization between the local storage system 990 and the other cluster, such that, the other cluster is timely updated with new and/or modified content within the local storage system 990.

In order to provide additional context for various embodiments described herein, FIG. 10 and the following discussion are intended to provide a brief, general description of a suitable computing environment 1000 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

In order to provide additional context for various embodiments described herein, FIG. 10 and the following discussion are intended to provide a brief, general description of a suitable computing environment 1000 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various example embodiments described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 5 GHz radio band at a 54 Mbps (802.11a) data rate, and/or a 2.4 GHz radio band at an 11 Mbps (802.11b), a 54 Mbps (802.11g) data rate, or up to a 600 Mbps (802.11n) data rate for example, or with products that contain both bands (dual band), so the networks can provide real-world performance similar to the basic “10BaseT” wired Ethernet networks used in many offices.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. In an example embodiment, when a processor executes instructions to perform “operations”, this could include the processor performing the operations directly and/or facilitating, directing, or cooperating with another device or component to perform the operations.

In the subject specification, terms such as “data store,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or API components.

Further, the various embodiments can be implemented as a method, apparatus, or article of manufacture using standard programming and/or engineering techniques to produce software, firmware, hardware, or any combination thereof to control a computer to implement one or more example embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A device, comprising:
at least one processor; and
at least one memory that stores executable instructions that, when executed by the at least one processor, facilitate performance of operations, comprising:
in response to an indication that a customer entity is eligible to upgrade a software product from an older version to a newer version, receiving software product data comprising change data that describes at least one change made to the newer version with respect to the older version;
based on customer data indicative of an implementation of the software product associated with the customer entity, generating tailored software product data that results from filtering the software product data to exclude elements that are determined not to be relevant to the implementation of the software product; and
causing a presentation of the tailored software product data via a customer device of the customer entity.

2. The device of claim 1, wherein the software product data comprises at least one of a release note associated with the newer version of the software product, source code associated with the newer version, or documentation associated with the newer version.

3. The device of claim 1, wherein the customer data comprises at least one of customer system topology data representative of a topology of customer computing equipment, customer system configuration data representative of a configuration of the customer computing equipment, customer system environment data representative of an environment associated with the customer computing equipment, or customer service request history data representative of at least one previous service request applied to the customer computing equipment.

4. The device of claim 1, wherein the operations further comprise generating role-based tailored software product data comprising filtering the tailored software product data to exclude elements that are determined not to be relevant to a defined role associated with the software product.

5. The device of claim 4, wherein the defined role is at least one of:
a service reliability engineer role that is authorized to handle feature elements associated with a scalability element or a reliability element of the software product;
a chief information security officer role that is authorized to handle feature elements associated with performance of a database element or a storage element of the software product; or
a database administrator role that is authorized to handle feature elements associated with security of the software product.

6. The device of claim 4, wherein the presentation of the tailored software product data comprises the presentation of the role-based tailored software product data to the customer device in response to a login being determined to be by an entity having the defined role.

7. The device of claim 1, wherein the operations further comprise generating user-based tailored software product data that results from filtering the tailored software product data to exclude elements that are determined to be not relevant to a defined user associated with the software product.

8. The device of claim 7, wherein the operations further comprise determining that a portion of the tailored software product data that relates to an improvement to a workflow, with which the defined user is associated, is relevant to the defined user and not relevant to a different user that is not associated with the workflow.

9. The device of claim 7, wherein the operations further comprise determining that a portion of the tailored software product data that relates to an improvement associated with a service request that was submitted by the defined user is relevant to the defined user and not relevant to a different user that did not submit the service request.

10. The device of claim 1, wherein the operations further comprise:
determining that a portion of the tailored software product data that relates to an improvement having a variable value that is a function of a deployment implementation of the software product;
determining the variable value based on the implementation of the software product associated with the customer entity; and
including the variable value in the presentation of the tailored software product data.

11. The device of claim 1, wherein the operations further comprise ordering the tailored software product data according to a determined weight that is specific to at least one of the customer entity, a defined role, or a defined user.

12. The device of claim 1, wherein the causing of the presentation comprises, in response to a determination that an intermediate version was released between the older version and the newer version, causing the presentation according to at least one of:
a separated presentation in which the tailored software product data is presented separately for the older version relative to the intermediate version and for the intermediate version relative to the newer version; or
an aggregated presentation in which the tailored software product data for the older version relative to the intermediate version and for the intermediate version relative to the newer version are combined.

13. The device of claim 1, wherein the operations further comprise leveraging at least one of a retrieval augmented generation system or a large language model to generate text for the presentation of the tailored software product data.

14. A device, comprising:
at least one processor; and
at least one memory that stores executable instructions that, when executed by the at least one processor, facilitate performance of operations, comprising:
in response to an indication that a customer entity is eligible to upgrade a software product from an older version to a newer version, receiving software product data comprising change data that describes at least one change made to the newer version with respect to the older version;
generating role-based tailored software product data that results from filtering the software product data to exclude elements that are determined not to be relevant to a defined role associated with the software product; and
presenting the role-based tailored software product data to a customer device of the customer entity in response to a login by an entity having the defined role.

15. The device of claim 14, wherein the operations further comprise, based on customer data indicative of an implementation of the software product associated with the customer entity, filtering the software product data to exclude elements that are determined not to be relevant to the implementation of the software product.

16. The device of claim 1, wherein the operations further comprise:
determining that a portion of the role-based tailored software product data that relates to a change of the at least one change having a variable value that is a function of a deployment implementation of the software product;
determining the variable value based on the implementation of the software product associated with the customer entity; and
including the variable value as part of the presenting of the role-based tailored software product data.

17. A method, comprising:
in response to an indication that a customer entity is eligible to upgrade a software product from an older version to a newer version, receiving, by a device comprising at least one processor, software product data comprising change data that describes changes made to the newer version with respect to the older version;
based on customer data indicative of an implementation of the software product by the customer entity, generating, by the device, tailored software product data based on filtering the software product data to exclude elements that are determined not to be relevant to the implementation of the software product; and
facilitating, by the device, a presentation of the tailored software product data to a customer device of the customer entity.

18. The method of claim 17, further comprising, generating, by the device, role-based tailored software product data based on filtering the tailored software product data to exclude elements that are determined not to be relevant to a defined role associated with the software product.

19. The method of claim 17, further comprising, generating, by the device, user-based tailored software product data based on filtering the tailored software product data to exclude elements that are determined not to be relevant to a defined user associated with the software product.

20. The method of claim 17, further comprising, ordering, by the device, the tailored software product data according to a determined weight function corresponding to at least one of the customer entity, a defined role, or a defined user.
